(19) United States
(12) Patent Application Publication
(10) Pub. No.: US 2022/0381086 A1
(43) Pub. Date: Dec. 1, 2022

(54) Expandable Gate

(71) Applicants: Lowell R. Roberts, Heltonville, IN (US); Tony J. Todd, Heltonville, IN (US); Danny L. Jones, Heltonville, IN (US)

(72) Inventors: Lowell R. Roberts, Heltonville, IN (US); Tony J. Todd, Heltonville, IN (US); Danny L. Jones, Heltonville, IN (US)

(21) Appl. No.: 17/747,162

(22) Filed: May 18, 2022

Related U.S. Application Data
(60) Provisional application No. 63/192,823, filed on May 25, 2021.

(51) Int. Cl. E06B 11/02

(52) U.S. Cl. CPC E06B 11/02; E04H 17/18

(57) ABSTRACT

The present invention relates generally to the field of fencing. More specifically, the present invention relates to an expandable gate used with livestock pens, corrals or other fencing The gate has a frame with at least one vertical member, at least one horizontal member, at least one horizontal expansion member, at least one diagonal member and at least one locking bolt. The horizontal expansion member can further be used to expand the width of the gate, and the frame can further be locked in the expanded position via a bolt that contacts a groove on the horizontal expansion member.

### CROSS-REFERENCE TO RELATED APPLICATION

The present application claims priority to, and the benefit of, U.S. Provisional Application No. 63/192,823, which was filed on May 25, 2021, and is incorporated herein by reference in its entirety.

### FIELD OF THE INVENTION

The present invention relates generally to the field of fencing. More specifically, the present invention relates to an expandable gate for a livestock or similar fence or corral area. The invention is comprised of a frame that has at least one vertical member, at least one horizontal member, at least one horizontal expansion member, at least one diagonal member and at least one locking bolt. The horizontal expansion member can further be used to expand the width of the gate, and the frame can be locked in the expanded position via a bolt that contacts a groove on the horizontal expansion member. In addition, the gate has a wheel assembly that allows the gate or closure to be easily moved. Furthermore, the invention has at least one latch and at least one hinge that allows the device to be secured to at least one fence post, thereby allowing the gate to swing open. Accordingly, the present disclosure makes specific reference thereto. Nonetheless, it is to be appreciated that aspects of the present invention are also equally applicable to other like applications, devices and methods of manufacture.

### BACKGROUND

Nearly every farm, ranch or other area where livestock is held, such as fairs, processing plants and holding pens, has at least one gate that may be used to secure the property, secure livestock or for some other purpose. However, existing gates known in the art have a fixed width and require the landowner to purchase a gate in a pre-existing dimension. However, farms typically have a variety types of farm equipment of differing sizes, such as tractors, trailers, wagons, spreaders and the like. In addition, the herding of livestock on a farm or ranch may require a number of different gates that must be of varying widths in order to channel or funnel livestock or a portion of a livestock herd into a specific area. As a result, a user must purchase gates that can accommodate their widest piece of farm equipment. However, this is undesirable as the gate may be unnecessarily large for the pen or other area where the livestock is to be held. In addition, a large gate may not be optimal when herding livestock into a specific secondary location, as the large gate allows too many of the animals to enter into the secondary location at one time, thereby requiring the farmer or rancher to cull the animals.

Therefore, there exists a long-felt need in the art for an improved gate. There also exists in the art a long-felt need for an expandable gate that allows a user to easily change the width of the gate per the specific needs of the area where the gate is to be positioned. Further, there exists a long-felt need in the art for a gate that allows a user to have access to multiple sizes within one gate or closure. Finally, there is a long-felt need in the art for an expandable gate that can be quickly expanded and locked into the expanded position.

The subject matter disclosed and claimed herein, in one embodiment thereof, comprises an expandable gate. The gate has a frame with at least one vertical member, at least one horizontal member, at least one horizontal expansion member, at least one diagonal member and at least one locking bolt. The horizontal expansion member can further be used to expand the width of the gate, and the frame can further be locked in the expanded position via a bolt that contacts a groove on the horizontal expansion member. In addition, the gate is comprised of a wheel assembly that allows the device to be easily moved from place to place. Furthermore, the gate has at least one latch and at least one hinge that allows the device to be secured to at least one fence post.

In this manner, the expandable gate of the present invention accomplishes all of the forgoing objectives and provides an improved gate. The device can further increase or decrease in width based on the needs of the user, and therefore allows a user to have access to gates of multiple sizes. In addition, the gate can be quickly expanded and locked into the expanded position and then changed back quickly to the original or other width.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises an expandable gate. The gate has a frame that has at least one vertical member, at least one horizontal member, at least one horizontal expansion member, at least one diagonal member and at least one locking bolt. All components of the frame are preferably manufactured from square or tubular metal such as, but not limited to, steel, aluminum and various metal alloys. Further, the width and length of the frame and the members can be varied as needed per the size requirements of the user. The outermost vertical members on each side of the frame have at least one hinge and at least one latch to allow the frame to be attached to and secured to at least one fence post.

It is further preferred that all members of the frame or at least the horizontal members are hollow, such that an interior space exists within the member. The top surface of the horizontal member includes at least one continuous opening that receives a bolt. The shaft of the bolt is positioned through the opening such that it resides within the interior space of the tubular metal from which the gate has been constructed. A horizontal expansion member also resides within the interior space of the horizontal member. The top surface of the member has a groove that receives the shaft of the bolt. Therefore, the expansion member can be slid in to or out of the interior space to allow the frame to be made shorter or longer in width. Once the member has been positioned at the desired location within the interior space to achieve the desired frame width, the body of the bolt can be turned until the shaft sufficiently contacts the groove to prevent the member from sliding further into or further out of the interior space. The groove may also have a fixedly-attached or removable and repositionable stop, which ensures the frame remains at the desired width, once the width has been set by the user using the expansion member.

The expansion member can be partially removed from one horizontal member in order to allow the frame to partially separate, such that only a portion of the frame may be opened while the rest of the frame remains stationary until both halves of the frame are rejoined by reinserting the expansion member and securing the member with the bolt. The frame may further have at least one wheel assembly with a u-shaped frame that may be fixedly or removably-attached to any member of the frame. The frame of the wheel assembly further receives at least one wheel that allows the frame to be easily pushed to allow the gate to be opened and closed when needed.

Accordingly, the expandable gate of the present invention is particularly advantageous as it provides a gate that can increase or decrease in width, based on the need of the user. Further, the device that allows a user to create a gate with multiple sizes or widths within one device. Finally, the device can be quickly expanded or shortened and locked into the expanded or shortened position.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an expandable gate of the present invention while attached to two fence posts in accordance with the disclosed architecture;

FIG. 2 illustrates a perspective view of one potential embodiment of an expandable gate of the present invention in accordance with the disclosed architecture;

FIG. 3 illustrates an enhanced perspective view of one potential embodiment of an expandable gate of the present invention in accordance with the disclosed architecture;

FIG. 4 illustrates an enhanced perspective view of one potential embodiment of an expandable gate of the present invention in accordance with the disclosed architecture;

FIG. 5A illustrates a perspective view of one potential embodiment of an expandable gate of the present invention while separated in accordance with the disclosed architecture;

FIG. 5B illustrates a perspective view of one potential embodiment of an expandable gate of the present invention while attached in accordance with the disclosed architecture; and

FIG. 6 illustrates a perspective view of one potential embodiment of a personalized and expandable gate of the present invention in accordance with the present invention.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved gate. There also exists in the art a long-felt need for an expandable gate that allows a user to easily change the width of the gate per his or her specific needs in order to cover the opening of the corral or pen. Further, there exists a long-felt need in the art for a gate that allows a user to have access to gates having an adjustable width within one single gate. Finally, there is a long-felt need in the art for an expandable gate that can be quickly expanded and locked into an expanded position.

The present invention, in one exemplary embodiment, includes an expandable gate device that is primarily comprised of a frame that has at least one vertical member, at least one horizontal member, at least one horizontal expansion member, at least one diagonal member and at least one locking bolt. All components of the frame are preferably manufactured from a square or tubular metal such as, but not limited to, steel, iron aluminum or metal alloys. Further, the width and length of the frame and the members can be adjusted as needed in accordance with the particular size requirements of the user. The outermost vertical members on each side of the frame have at least one hinge and at least one latch to allow the frame to be attached to and secured to at least one fence post. All members of the frame and the horizontal members are preferably hollow, such that an interior space exists within each of the frame members.

The top surface of the horizontal member has at least one continuous opening that receives a bolt or other fastening member. The shaft of the bolt is positioned through the opening such that it is positioned within the interior space. A horizontal expansion member also resides within the interior space of the horizontal member to accommodate the fastening member. The top surface of the fastening member has a groove that receives the shaft of the bolt to allow the expansion member to be slid in to or out of the interior space, which in turn allows the width of the frame to become smaller or larger. Once the fastening member has been positioned at the desired location within the interior space to achieve the desired frame width, the body of the bolt can then be turned until the shaft sufficiently contacts the groove to prevent the fastening member from sliding further into or further out of the interior space. The groove may also have a fixedly-attached or removable and repositionable stop which ensures the frame remains at the desired width when in use, once the width has been set by the user using the expansion member.

Additionally, the expansion member can be partially removed from one horizontal member in order to allow the frame to partially separate, such that only a portion of the frame may be opened while the rest of the frame remains stationary until both halves of the frame are rejoined by reinserting the expansion member and securing the member with the bolt. The frame may further include at least one wheel assembly having a generally u-shaped frame, that may be fixedly or removably-attached to any member of the frame. Alternatively, in lieu of a wheel, a skid or ski may be used and placed on the bottom of the gate to allow the gate to be moved over muddy ground or snow without a wheel getting caught in the mud or snow. The frame of the wheel assembly further receives at least one wheel or skid that allows the frame to be easily pushed to allow the gate to easily open and close when needed.

Accordingly, the expandable gate of the present invention is particularly advantageous as it provides a gate that can increase or decrease in width based on the needs of the user. Further, the device allows a user to have access to gates that can be changed to multiple widths and lengths. Finally, the device can be quickly expanded and locked into the expanded position. The gate may also have removable padding applied over the bars to reduce the risk to animals and equipment when traversing the opening.

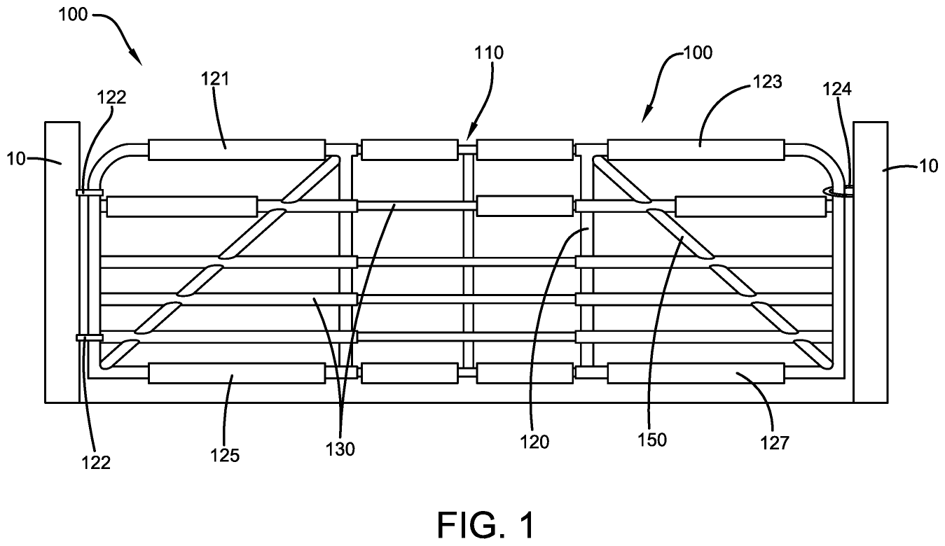

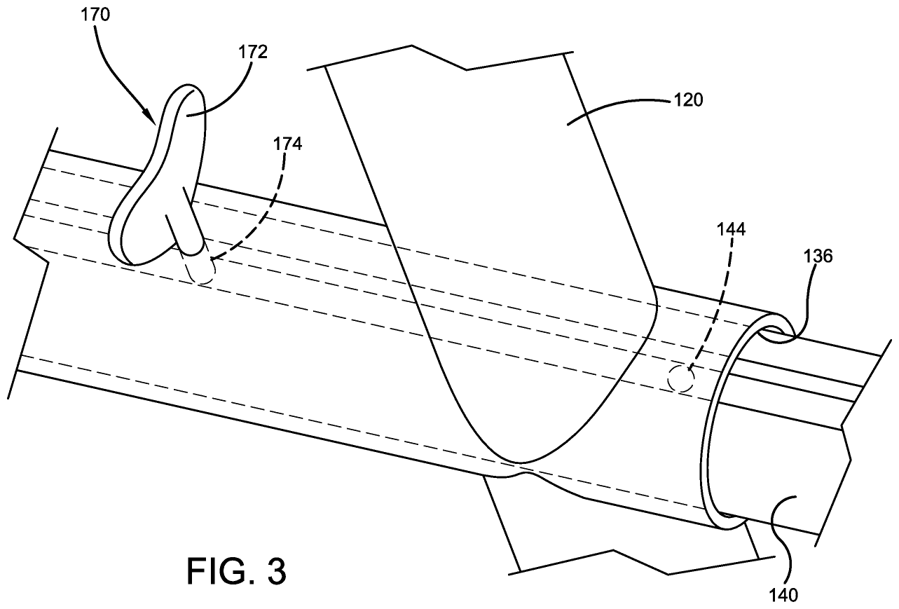

Referring initially to the drawings, FIG. 1 illustrates a perspective view of one potential embodiment of an expandable gate 100 of the present invention while attached to two fence posts 10 in accordance with the disclosed specification. The device 100 has a frame 110 with at least one vertical member 120, at least one horizontal member 130, at least one horizontal expansion member 140, at least one diagonal or bracing member 150 and at least one locking bolt 170 (see FIG. 3). All components of the frame 110 are manufactured from square or tubular metal, such as but not limited to steel, iron, aluminum or other metal alloys, unless otherwise specific herein. It is further contemplated that in any embodiment, the width and length of the frame 110 and the members 120, 130, 140, 150 can be varied as needed per the size requirements of the opening of the corral or livestock pen. Further, the members can be arranged 120, 130, 140, 150 in any suitable position, orientation or arrangement that ensures structural stability to the frame 110. In addition, the frame elements can be personalized to create an emblem of the ranch or farm.

In order to allow the frame 110 to attach to at least one fence post 10, the outermost vertical members 120 on each side of the frame 110 have at least one (but preferably two) hinge elements 122 and at least one latch 124. The hinge 122 may be adjustable or fixed in position on the vertical frame member 120. The hinge 122 and the latch 124 are of a type known in the art with specific respect to fences and gates. The latch 124 further allows the frame 110 to be secured or unsecured from a fence post 10 by lifting or lowering the latch 124. The hinge 122 further allows the device 100 to pivot around the fence post 10 opposite the latch 124. In differing embodiments, the hinge 122 and the latch 124 may be removably or fixedly-secured to the vertical member 120. Padding 121, 123, 125 and 127 may be added to different portions of the frame 110 of the gate 100. The padding elements are movable and removable so as to avoid damage to livestock or equipment traversing the gate.

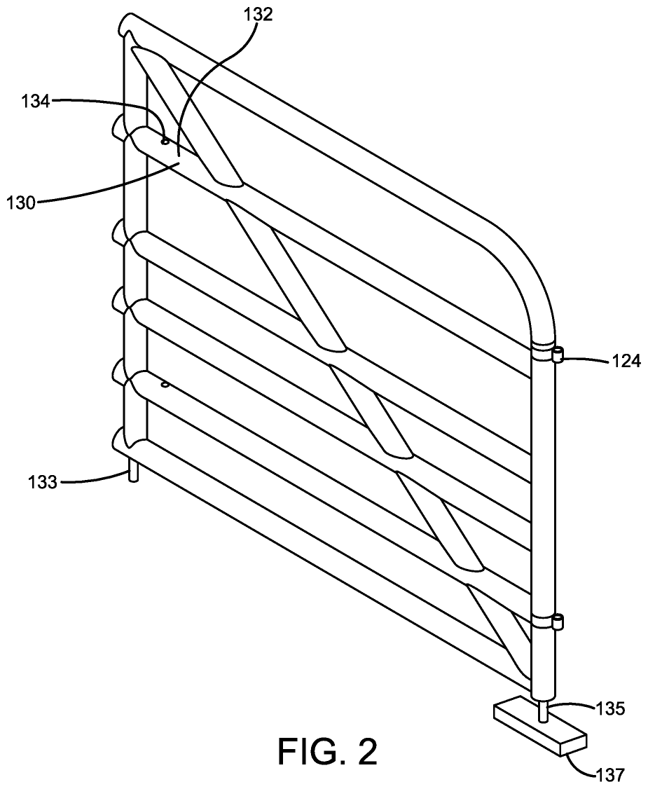

FIG. 2 illustrates a perspective view of one potential embodiment of an expandable gate device 100 of the present invention in accordance with the disclosed specification. It is further preferred that all members 120, 130, 140, 150 of the frame 110 or at least the horizontal members 130 are hollow, such that an interior space 136 exists within each of the members 120, 130, 140, 150. Further, any surface of any member 120, 130, 140, 150, but preferably the top surface 132 of the horizontal member 130, has at least one continuous opening 134. FIG. 2 also shows a skid 137 attached to the base of one of the extending elements 135 which can be used to move the gate 100 along muddy surfaces or through snow. In addition, the skid 137 can be used as a foot to prevent the gate from sinking in wet soil or mud when it is not suspended between fence posts.

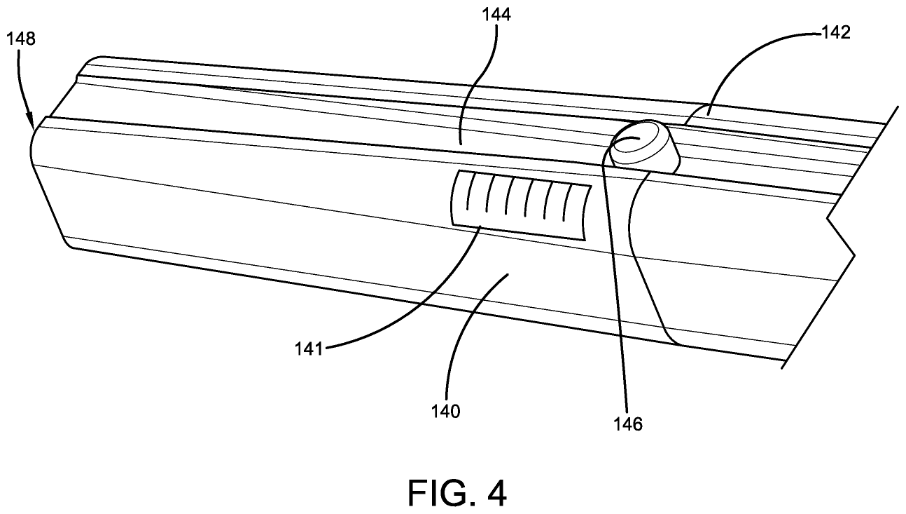

FIG. 3 illustrates an enhanced perspective view of one potential embodiment of an expandable gate 100 of the present invention in accordance with the disclosed structure. The continuous opening 134 further receives at least one bolt or fastening member 170 that may be of any threaded or slot bolt type or other pin such as a “carter” pin having a head, and in one embodiment is preferably a wing nut bolt. The shaft 174 of the bolt 170 is positioned through the opening 134 such that it resides within the interior space 136. A horizontal expansion member 140 further resides within the interior space 136 of the horizontal member 130, and the ends 148 of the member 140 are preferably tapered. In differing embodiments, the member 140 may also be vertical and reside in the interior space of the vertical member 120 such as shown in FIG. 2. The top surface 142 (or in any alternative embodiment, any surface) of the member 140 includes a groove 144 that receives the shaft 174 of the bolt 170. In one embodiment, the groove 144 is on the bottom surface of the member 140 to remain protected from weather. To this effect, the expansion member 140 can be slid in to or out of the interior space 136 to allow the frame 110 to become smaller or larger in width, as needed to fill the opening to the corral or livestock pen. Once the member 140 has been positioned at the desired location within the interior space 136 to achieve the desired frame 110 width, the body 172 of the bolt 170 can be turned until the shaft 174 sufficiently contacts the groove 144 to prevent the member 140 from sliding further into or out of the interior space 136, as best seen in FIG. 4. In addition, the groove 144 may have a fixedly-attached or removable and repositionable stop 146 that is attached to the shaft 174 of the bolt 170 in the event that the member 140 attempts to slide inwards into the interior space. In this regard, both the bolt 170 and the stop 146 ensure the frame 110 remains at the desired width once the width has been set by the user using the expansion member 140, 133, and/or 135. Each expansion member 140 may also include a gauge 141 to aid the user in setting each expansion member at the correct position whether horizontally or vertically.

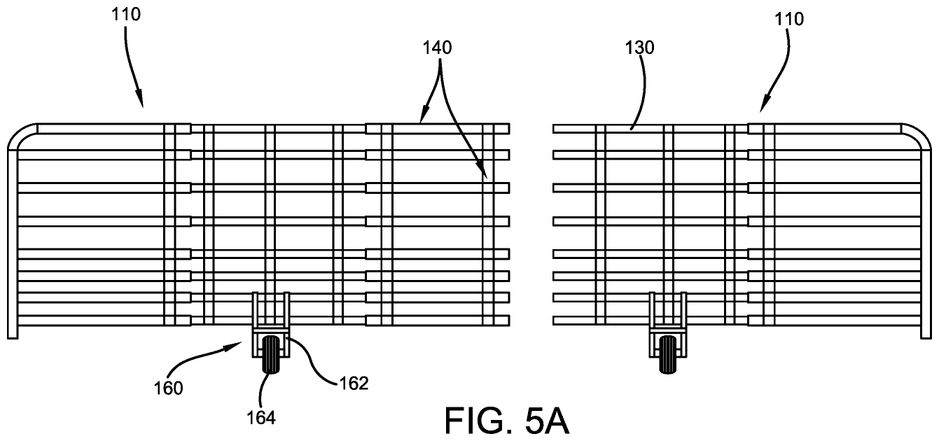

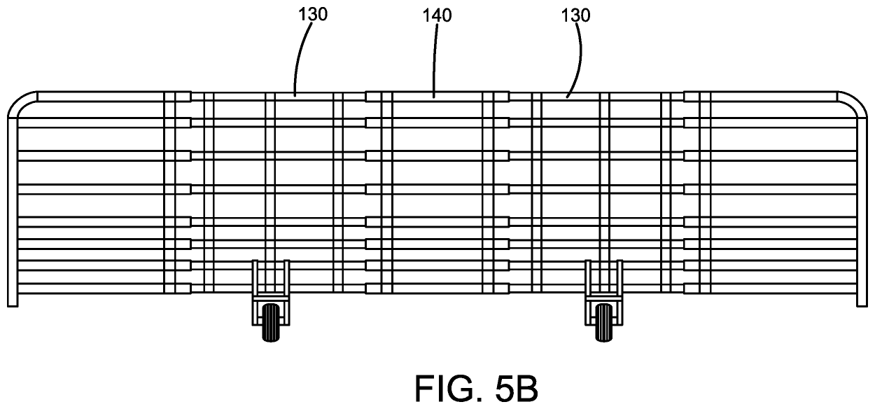

FIG. 5A and FIG. 5B illustrates perspective views of one potential embodiment of an expandable gate 100 of the present invention while separated and while attached in accordance with the disclosed specification. It is contemplated that the expansion member 140 can be partially removed from one vertical member 120 in order to allow the frame 110 to partially separate into individual portions. In this manner, only a portion of the frame 110 may be opened while the rest of the frame 110 remains stationary (and attached to a fence post 10) until both halves of the frame 110 are rejoined by reinserting the expansion member 140 and securing the member 140 with the bolt 170 or bolts 170. In order to facilitate the movement of the frame 110 over a ground surface 12, the frame 110 may further include at least one wheel assembly 160 or skid 137 (see FIG. 2). The assembly 160 has a generally u-shaped frame 162 that may be fixedly or removably-attached to any member 120, 130, 140, 150 of the frame 110. In one optional embodiment, the frame 162 further receives at least one wheel 164 or skid, ski or foot that allows the frame 110 to be easily pushed to allow the device 100 to easily open and close when needed.

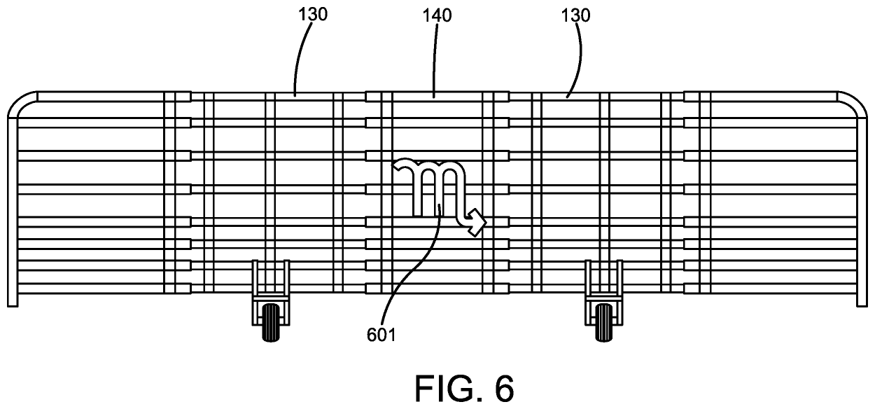

FIG. 6 shows the gate assembly 100 of the present invention in which the frame 110 has been provided with a personalized indicia 601 in the form of an “M.” Any other shapes, designs or the like are possible depending on the personalization preferences of the individual purchasing the gate.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “expandable gate device” and “device” are interchangeable and refer to the expandable gate device 100 of the present invention.

Notwithstanding the forgoing, the expandable gate device 100 of the present invention and its various components can be of any suitable size and configuration as is known in the art without affecting the overall concept of the invention, provided that they accomplish the above-stated objectives. One of ordinary skill in the art will appreciate that the size, configuration and material of the expandable gate device 100 as shown in the FIGS. are for illustrative purposes only, and that many other sizes and shapes of the expandable gate device 100 are well within the scope of the present disclosure. Although the dimensions of the expandable gate device 100 are important design parameters for user convenience, the expandable gate device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gate for use with livestock pens and corrals, the gate comprising:
a frame having a series of horizontal element and vertical elements, each of the horizontal and vertical elements having a rigid outer surface and a hollow interior;
a least one slidable expansion element contained in at least one of the horizontal elements or vertical elements;
a locking element for holding the at least one expansion element in position; and
at least one movable stop for holding the locking element in position.

2. The gate for use with livestock pens and corrals as recited in claim 1, wherein the gate further comprises at least one of a wheel, skid, ski or foot provided in at least one of the vertical elements.

3. The gate for use with livestock pens and corrals as recited in claim 1, wherein a gauge is provided adjacent the at least one slidable element to determine position of the slidable expansion element.

4. The gate for use with livestock pens and corrals as recited in claim 1, wherein a slidable expansion element is provided in a plurality of horizontal elements.

5. The gate for use with livestock pens and corrals as recited in claim 1, wherein a slidable expansion element is provided in a plurality of vertical elements.

6. The gate for use with livestock pens and corrals as recited in claim 1, wherein a slidable expansion element is provided in at least one vertical element and at least one horizontal element.

7. The gate for use with livestock pens and corrals as recited in claim 1, wherein the gate is separable into first and second portions.

8. The gate for use with livestock pens and corrals as recited in claim 7, wherein at least one of the horizontal elements and at least one of the vertical elements of each of the first and second portions is provided with expansion elements.

9. The gate for use with livestock pens and corrals as recited in claim 8, wherein each of the expansion elements is provided with a locking pin and movable stop.

10. The gate for use with livestock pens and corrals as recited in claim 9, wherein each of the expansion elements is provided with a gauge.

11. The gate for use with livestock pens and corrals as recited in claim 10, wherein each of the expansion elements for the vertical elements includes one of a wheel, skid, ski or foot.

12. An expandable closure for a fenced area, the expandable closure comprising:
a frame comprised of a plurality of horizontal bars, vertical bars and diagonal bars, each of the plurality of bars formed from a tubular metal;
each of the horizontal bars having an expansion element with a groove therein;
each of the expansion elements having a bolt or pin to hold the expansion element in a selected position; and
each of the expansion elements cooperating with a movable stop to hold the bolt or pin in position.

13. The expandable closure for a fenced area as recited in claim 12, wherein at least one of the vertical members is comprised of an expansion member.

14. The expandable closure for a fenced area as recited in claim 13, wherein the expansion member in the at least one of the vertical member is comprised of one of a wheel, skid, ski or foot connected to the expansion member.

15. The expandable closure for a fenced area as recited in claim 12, wherein each of the expansion elements and expansion members is comprised of gauge to determine the distance of expansion.

16. The expandable closure for a fenced area as recited in claim 14, wherein each vertical member has an expansion member.

17. The expandable closure for a fenced area as recited in claim 12, wherein at least one of the horizontal bars and vertical bars is comprised of a removable padding.

18. The expandable closure for a fenced area as recited in claim 12, wherein the horizontal bars can be adjusted in a width wise direction and the vertical bars can be adjusted in a vertical direction.

19. An expansion gate comprising:
a plurality of horizontal tubular bars and a plurality of vertical tubular bars intersecting the horizontal bars;
each of the horizontal bars having an expansion element for increasing a width of the gate;
each of the expansion elements having a groove and a movable stop within the groove; and
each of the expansion elements having a pin or bold for insertion in the groove to expand the horizontal tubular bars in a width direction.

20. The expansion gate as recited in claim 19, wherein each of the vertical tubular bars has an expansion element for raising the gate in a vertical direction.
